(19) United States
(12) Patent Application Publication
(10) Pub. No.: US 2001/0030631 A1
(43) Pub. Date: Oct. 18, 2001

(54) Optical system for head mounted display

(75) Inventor: Jong Bae Park, Suwon-si (KR)

Correspondence Address: Benjamin J. Hauptman, Suite 310, 1700 Diagonal Road, Alexandria, VA, 22314, US

(73) Assignee: DAEYANG E & C Co., Ltd.

(21) Appl. No.: 09/833,591

(22) Filed: Apr. 13, 2001

(30) Foreign Application Priority Data
Apr. 15, 2000 (KR) 2000-19865

(51) Int. Cl. G09G 5/00

(52) U.S. Cl. 345/8

(57) ABSTRACT

The present invention provides an optical system for a head mounted display. The optical system of the present invention comprises a light source, a reflector for diffusing light from the light source, a reflection-type liquid crystal display panel for displaying an image by means of the light which is irradiated from the reflector, and a prism disposed in front of the reflector for magnifying the image of the liquid crystal display panel. In particular, the light source is a light emitting diode, and the reflector is constructed to be aspheric such that distortion aberration of the image of the liquid crystal display panel, which is emitted from the reflector, can be corrected. According to the present invention, an advantage of enhancing light efficiency can be obtained by including the light emitting diode and the reflector for diffusing the light generated from the light emitting diode. Further, another advantage of reducing production cost can be obtained by using an inexpensive reflection-type liquid crystal display.

### FIELD OF INVENTION

The present invention relates to a head mounted display, and more particularly, to an optical system for the head mounted display wherein optimal images can be provided to a wearer by enhancing efficiency of a light source and the unit cost of production thereof can be reduced.

### BACKGROUND OF INVENTION

The head mounted display is a device for reproducing video signals through a built-in screen thereof, and comprises an optical system including a liquid crystal panel, an illumination device, a lens, etc. Such optical system can be variously constructed in accordance with an arrangement structure of the components thereof. As an example, optical systems generally used are schematically shown in FIG. 1 and FIG. 2. Taking these figures into consideration, the optical system shown in FIG. 1 is constructed to include a liquid crystal display panel 1 for displaying an image, an illumination device 2 being a light source and disposed behind the liquid crystal display panel 1, and an eye lens 3 disposed in front of the liquid crystal display panel 1.

Further, the optical system shown in FIG. 2 is constructed in such a manner that a liquid crystal display panel is horizontally disposed, that a polarized beam splitter 4 is disposed at an angle of about 45° right below the liquid crystal display panel 1, and that a concave reflecting mirror 5 for magnifying and reflecting an image of the liquid crystal display panel 1 reflected by the polarized beam splitter 4 is behind the beam splitter 4. The illumination device 2 is also disposed behind the liquid crystal display panel 1 in the same manner as FIG. 1. Herein, the liquid crystal display panel 1 shown in FIG. 1 and FIG. 2 is a backlight liquid crystal display panel and is constructed to display the image by using the illumination device 2, disposed behind the panel 1, as a light source.

Although the conventional optical system of FIG. 1 constructed as such has an advantage in that its constitution is simple and its production cost is low, there is a disadvantage in that the eye lens 3 should be thick in order to realize a large screen for the optical system. Further, the optical system of FIG. 2 has a disadvantage in that a sufficient space for installing the illumination device 2 and the polarized beam splitter 4 is required. In particular, the optical system of FIG. 2 is superior to that of FIG. 1 in that the polarized beam splitter 4 can be used to enhance a visibility of the image, but a problem still exists in that an eye shape of the wearer is projected on the concave reflecting mirror 5.

In FIG. 3, another example of an optical system for a head mounted display is shown. In the conventional optical system shown in FIG. 3, the liquid crystal display panel 1 is disposed to face downward at an angle of about 45°, the illumination device 2 is disposed behind the liquid crystal display panel, and a prism 6 is disposed in front of the liquid crystal display panel 1. The liquid crystal display panel 1 is a backlight liquid crystal display panel in the same manner as FIG. 1 and FIG. 2, and is constructed to display the image by using the illumination device 2 disposed behind as a light source and to face a plane of incidence of the prism 6. On the other hand, the prism 6 is a polyhedron having a plane of incidence 6a, a plane of reflection 6b and a light-emerging plane 6c. The plane of incidence 6a and the light-emerging plane 6c are concave while the plane of reflection 6b is convex. The prism 6 is used to magnify the image of the liquid crystal display panel 1. In particular, the large screen can be realized by magnifying the light of the image of the liquid crystal display panel 1 several times through the concave plane of incidence 6a and light-emerging plane 6c and the convex plane of reflection 6b.

On the other hand, since the optical system of FIG. 3 constructed as such has a constitution in which its components are arranged nearly vertically, it has an advantage of its slimness and compactness. However, there is a shortcoming in that the production cost is increased since expensive backlight liquid crystal display panel 1 should be used as mentioned above. Further, there is also another shortcoming in that light efficiency is lowered since the light source should be provided to an entire rear surface of the backlight liquid crystal display panel 1. These shortcomings deteriorate image quality.

### SUMMARY OF INVENTION

Therefore, the present invention is contemplated to solve the problems mentioned above. The object of the present invention is to provide an optical system for a head mounted display, which is constructed such that optimal images can be provided to a wearer by enhancing the light efficiency and the unit cost of production can be reduced by using inexpensive parts when manufacturing the optical system.

In order to achieve the above object, the present invention provides an optical system for a head mounted display, which comprises a light source; a reflector for diffusing light from the light source, a reflection-type liquid crystal display panel for displaying an image by means of the light that is irradiated from the reflector, and a prism disposed in front of the reflector for magnifying the image of the liquid crystal display panel.

Preferably, the light source is a light emitting diode, and the reflector is constructed to be aspheric such that distortion aberration of the image of the liquid crystal display panel, which is emitted from the reflector, can be corrected.

### BRIEF DESCRIPTION OF THE DRAWINGS

FIG. 1 is a schematic view showing the constitution of a conventional optical system for a head mounted display.

FIG. 2 and FIG. 3 are schematic views showing other examples of conventional optical systems for a head mounted display.

FIG. 4 is a schematic view showing a constitution and arrangement of an optical system for a head mounted display according to the present invention.

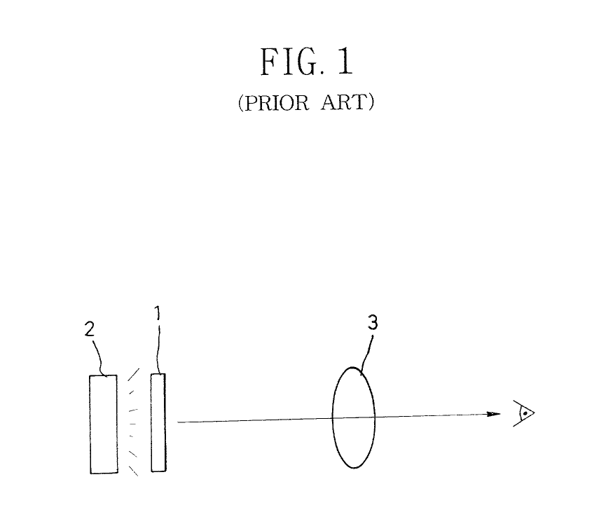

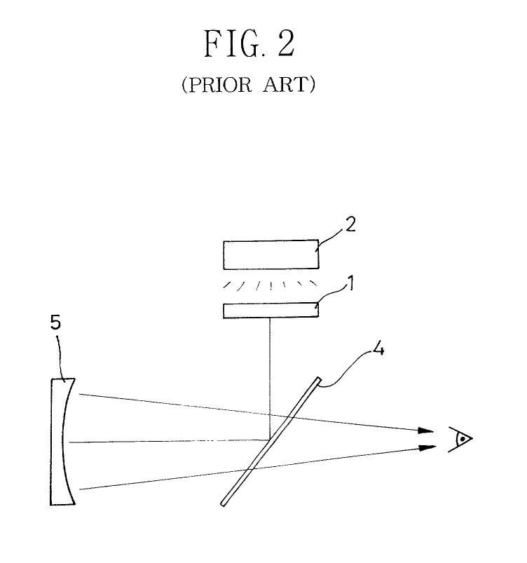

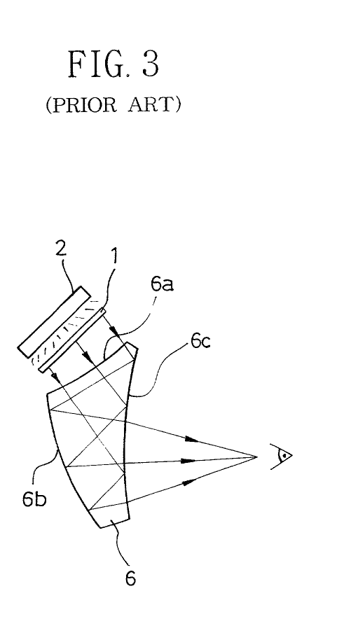

### DETAILED DESCRIPTION FOR PREFERRED EMBODIMENT

Hereinafter, a preferred embodiment of an optical system for a head mounted display according to the present invention will be explained in detail with reference to the accompanying drawing.

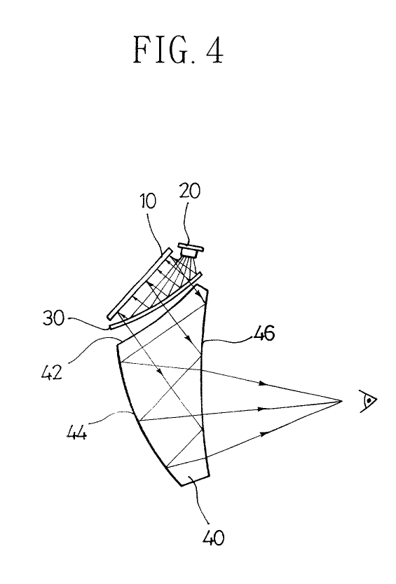

FIG. 4 schematically shows the constitution and arrangement of the optical system for the head mounted display according to the present invention. First, as shown in FIG. 4, the optical system for the head mounted display according to the present invention is provided with a liquid crystal display panel 10 for displaying an image. The liquid crystal display panel 10 is a frontlight liquid crystal display panel for displaying an image by means of a light source irradiating the light in front of the panel and is disposed to face downward at an angle of about 45°. The frontlight liquid crystal display panel 10 has a characteristic that it is inexpensive. The constitution and operation of the frontlight liquid crystal display panel has been already well known, and thus detailed descriptions thereof will be omitted.

In addition, a light source 20 is disposed at a front upper position with respect to the liquid crystal display panel 10, and a reflector 30 is disposed in front of the liquid crystal display panel 10. The light source comprises a light emitting diode 20 which, in turn, irradiates the light toward a front face of the panel 10. The light emitting diode 20 may comprise a red light emitting diode, a green light emitting diode, a blue light emitting diode, and a white light emitting diode. The reflector 30 is a sort of reflecting mirror having high transmissivity, and is used to reflect and irradiate the light generated from the light emitting diode 20 toward the front face of the liquid crystal display panel 10. In particular, the reflector 30 is also used to diffuse the light generated from the light emitting diode 20 in order to irradiate the light of the light emitting diode 20 uniformly to the front face of the liquid crystal display panel 10. Since the constitution and operation of the reflector 30 has been already well known, the detailed descriptions thereof will be omitted.

On the other hand, the reflector 30 reflects the light from the light emitting diode 20, and is disposed at a predetermined angle with respect to the liquid crystal display panel 10 in order to transmit the light of the image of the liquid crystal display panel 10. Further, the reflector 30 is constructed to be aspheric in order to correct a distortion aberration of the image as well as to enhance image resolution thereof. The aspheric surface is a surface of which radius of curvature is gradually increased along the direction from its central portion to its peripheral portion, i.e., a surface which gradually flattens along the direction from its central portion to its peripheral portion. The surface is used to correct the distortion of the image of the liquid crystal display panel, which passes through the reflector 30.

In addition, the optical system of the present invention includes a prism 40. The prism 40 is a polyhedron having a plane of incidence 42, a plane of reflection 44 and a light-emerging plane 46. The plane of incidence 42 and the light-emerging plane 46 are concave, while the plane of reflection 44 is convex. The prism 40 is disposed in a vertical direction such that the plane of incidence 42 is placed below the reflector 30, and is used to magnify the image of the liquid crystal display panel which is incident through the plane of incidence 42. In particular, the image is magnified in order to realize a large screen by reflecting the image of the liquid crystal display panel 10 several times through the concave plane of incidence 42 and light-emerging plane 46 and the convex plane of reflection 44.

Next, the operation and effect of the present invention having the foregoing constitution will be described. First, when the light is generated from the light emitting diode 20 under the condition that a signal is applied to the liquid crystal display panel 10, the light is reflected at a predetermined angle through the reflector 30 and is irradiated to the liquid crystal display panel 10. At this time, the light of the light emitting diode 20 is reflected by the reflector 30 and is simultaneously diffused, and then is uniformly irradiated throughout a front surface of the liquid crystal display panel 10. Under such condition, the liquid crystal display panel 10 uses the light from the light emitting diode 20 as a light source and displays the image.

On the other hand, the image of the liquid crystal display panel 10 is transmitted to the reflector 30 and is incident on the prism 40. The light of the image that is incident on the prism 40 is reflected to the light-emerging plane 46. The reflected light is magnified while it is again reflected to the plane of reflection 44. Finally, the light is emitted forwardly through the light-emerging plane 46. Therefore, the wearer of the head mounted display can see the largely magnified image through the light-emerging plane 46 of the prism 40.

From the foregoing, the optical system of the present invention has an advantage in that the light efficiency can be enhanced since it includes the light emitting diode and the reflector for diffusing the light generated from the light emitting diode. Further, the optical system has another advantage in that its production cost can be reduced since inexpensive reflection-type liquid crystal display can be used therein.

The foregoing is to explain merely the preferred embodiment of the present invention, and the scope of the applicability of the present invention is not limited to the description as set forth herein. Thus, various other modifications or changes can be made without departing from the scope and spirit of this invention. For example, the present invention can be variously embodied by modifying the shapes and constitutions of the components described specifically in the embodiment of the present invention.

What is claimed is:

1. An optical system for a head mounted display, comprising:
a light source;
a reflector for diffusing light from said light source;
a reflection-type liquid crystal display panel for displaying an image by means of said light which is irradiated from said reflector; and
a prism disposed in front of said reflector for magnifying said image of said liquid crystal display panel.

2. The optical system as claimed in claim 1, wherein said light source is a light emitting diode and is disposed at a front upper position with respect to said liquid crystal display panel.

3. The optical system as claimed in claim 1, wherein said reflector is constructed to be aspheric such that distortion aberration of said image of said liquid crystal display panel can be corrected, said image emerging from said reflector.
